(19) United States
(12) Patent Application Publication
(10) Pub. No.: US 2026/0346232 A1
(43) Pub. Date: Nov. 5, 2026

(54) FILTER AID COMPOSITE

(71) Applicant: IMERYS USA, INC., Roswell, GA (US)

(72) Inventors: David GITTINS, San Jose, CA (US); James DAVIS, Cumming, GA (US); Li-Chih HU, Sacramento, CA (US); Kyle FLOTLIN, Seattle, WA (US)

(21) Appl. No.: 19/099,384

(22) PCT Filed: Jul. 26, 2023
(86) PCT No.: PCT/US2023/028643

§ 371 Date: Jan. 28, 2025

Related U.S. Application Data
(60) Provisional application No. 63/369,803, filed on Jul. 29, 2022.

(51) Int. Cl. B01J 20/32; B01J 20/26; B01J 20/28

(52) U.S. Cl. CPC B01J 20/3214; B01J 20/262; B01J 20/28097

(57) ABSTRACT

A composition comprising a cross-linked binder and mineral particles selected from the group consisting of: i) expanded milled perlite particles having a D₅₀ from about 5 to about 40 microns; ii) diatomaceous earth particles having a D₅₀ of from about 10 to about 50 microns; and combinations thereof; wherein the mineral particles are bound together by the cross-linked binder to form composite particulates wherein the composite particulates have a D₅₀ of from about 20 to 100 microns.

### TECHNICAL FIELD

The present disclosure concerns a composition comprising composite particulates and a cross-linked binder, and methods of preparation of the composition. The present disclosure also concerns filter aid materials comprising the composition and methods of filtering liquids using the composition.

### BACKGROUND

Filtration devices typically include a filter aid which comprises solid particles that improve filtering efficiency. The filter aid is either added to the suspension to be filtered or placed on the filter as a layer through which the liquid must pass.

Filter aids are usually comprised of materials derived from volcanic glass, such as perlite or pumice. Perlite filter aids are advantageously lightweight, inert, impart no taste or odour to liquids being filtered, and are virtually insoluble in mineral and organic acids at all temperatures.

Diatomaceous earth (DE) is another useful type of filter aid material and is a naturally occurring sand made from the fossilized remains of diatoms is a material which is commonly present. Diatomaceous earth-based filter aids are typically used for the primary clarification of beer and wine.

Customers in the beer and wine industries are increasingly looking to shift away from standard DE-based filter aids due to heath and regulatory concerns with the crystalline silica typically also present. Perlite-based filter aids also may suffer from problems with achieving target clarity. Cross-flow wine and beer filtration devices normally operate at a high cost. Therefore, it would be desirable to provide a filter aid which contains no crystalline silica, is low-cost and achieves the clarity of standard DE-containing filter aids.

### SUMMARY

In the following description, certain aspects and embodiments will become evident. It is contemplated that the aspects and embodiments, in their broadest sense, could be practiced without having one or more features of these aspects and embodiments. It is also contemplated that these aspects and embodiments are merely exemplary.

According to a first aspect, there is provided a composition comprising composite particulates, the composite particulates comprising a cross-linked binder and mineral particles selected from the group consisting of: i) expanded milled perlite particles having a D₅₀ from about 5 to about 40 microns; ii) diatomaceous earth particles having a D₅₀ of from about 5 to about 40 microns; and combinations thereof; wherein the mineral particles are bound together by the cross-linked binder to form composite particulates wherein the composite particulates have a D₅₀ of from about 20 to 100 microns, and wherein the binder is present in an amount of 0.01 to 20 wt %, based on the total weight of the composition wherein the cross-linked binder is a reaction product of a polymer and a cross-linking agent, wherein the polymer is selected from water-soluble synthetic polymers and natural water-soluble polymers.

According to a second aspect, there is provided a filter aid material comprising the composition according to the first aspect.

According to a third aspect, there is provided a method of filtering a liquid comprising contacting the liquid with a filter aid material according to the second aspect.

According to a fourth aspect, there is provided a method of preparing the composition according to the first aspect.

The skilled person will appreciate that, except where mutually exclusive, a feature described in relation to any one of the above aspects may be applied Mutatis mutandis to any other aspect. Furthermore, except where mutually exclusive, any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 depicts an X-ray diffraction (XRD) spectra showing the levels of crystallinity (peaks) of a comparative diatomaceous earth sample, a comparative perlite sample and a novel composite sample of diatomaceous earth and expanded milled perlite.

FIG. 2 depicts a Walton filtration plot of turbidity vs pressure rise showing the turbidity for comparative diatomaceous earth samples, comparative perlite samples and two novel composite samples of diatomaceous earth and expanded milled perlite.

FIG. 3 depicts a Mercury porosimetry plot of intrusion volume vs pore size of comparative diatomaceous earth samples, a comparative perlite sample and two novel composite samples of diatomaceous earth and expanded milled perlite.

### DETAILED DESCRIPTION

Reference will now be made in detail to exemplary embodiments, shown in the accompanying drawings.

It has been surprisingly found that a composition comprising composite particulates comprising a cross-linked binder and mineral particles selected from expanded milled perlite, diatomaceous earth particles and combinations thereof achieve excellent filtration performance results.

### Expanded Milled Perlite Particles

Perlite typically contains the following components: silicon dioxide, aluminium oxide, sodium oxide, potassium oxide, iron oxide, magnesium oxide, calcium oxide, water and small amounts of other metallic elements.

The perlite particles of the present invention are in the form of expanded perlite. Typically, expanded perlite includes one or more cells, or parts of cells, in which a cell is a void space partially or entirely surrounded by walls of glass, usually formed from expansion of gases when the glass is in the softened state. Processes for expanding perlite may include heating perlite in air to a temperature of least about 700 °C, typically between 800 °C and 1100 °C, in an expansion furnace. Exemplary processes for producing expanded perlite are described in US 2006/0075930, the entire contents of which is hereby incorporated by reference. Expanded perlite typically has a bulk volume up to 20 times that of the unexpanded material.

In accordance with the present invention, the perlite is milled after it has been expanded in the expansion furnace.

Unless otherwise specified, the particle size properties referred to herein for the perlite particles are as measured by the method employed in the art of laser light scattering, using a CILAS 1064L particle size analyser, as supplied by CILAS (or by other methods which give essentially the same result). In the laser light scattering technique, the size of particles in powders, suspensions and emulsions may be measured using the diffraction of a laser beam, based on an application of Fraunhofer and Mie theory. Such a machine provides measurements and a plot of the cumulative percentage by volume of particles having a size, referred to in the art as the ‘equivalent spherical diameter’ (e.s.d), less than given e.s.d values. The mean particle size D₅₀ is the value determined in this way of the particle e.s.d at which there are 50% by volume of the particles which have an equivalent spherical diameter less than that d₅₀ value.

According to the present invention, the expanded milled perlite particles have a D₅₀ from about 10 to about 50 microns, such as from about 15 to about 45 microns, or from about 20 to about 40 microns, or from about 25 to about 35 microns. In certain embodiments, the expanded milled perlite particles have a D₅₀ of about 15 microns.

In certain embodiments, the expanded milled perlite particles have a bulk density of from about 0.05 g/cm³ to about 0.20 g/cm³, such as from about 0.06 g/cm³ to about 0.19 g/cm³, such as from about 0.07 g/cm³ to about 0.18 g/cm³, such as from about 0.08 g/cm³ to about 0.17 g/cm³, such as from about 0.09 g/cm³ to about 0.16 g/cm³, such as such as from about 0.10 g/cm³ to about 0.15 g/cm³, such as from about 0.11 g/cm³ to about 0.14 g/cm³, such as from about 0.12 g/cm³ to about 0.13 g/cm³.

In one embodiment, the perlite product is obtained from a commercially available perlite product. In another embodiment, the at least one perlite product is a Harborlite® material available from Imerys Performance Materials.

### Diatomaceous Earth (DE) Particles

Diatomaceous earth (DE) is derived from the remains of microscopic fossilized sea or freshwater algaes. DE is typically employed as a filter aid. DE is known from having an intricate and porous structure which is effective for entrapping particles in filtration processes.

The DE starting material may be DE in its crude form or may have been subjected to one or more processing steps such as physical or chemical modification. Physical modification processes include, but are not limited to, milling, drying and air classifying. Chemical modification processes include, but are not limited to, silanization. Such a modification process is used to render the surfaces of DE either more hydrophobic or hydrophilic using the methods such as those described in U.S. Pat. Nos. 3,915,735 and 4,260,498, the contents of which are incorporated herein by reference.

DE typically comprises about 80 to 90% silica, with 2 to 4% alumina (attributed mostly to clay minerals), and 0.5-2% iron oxide. The types of DE available are well-known to the person skilled in the art.

Unless otherwise specified, the particle size properties referred to herein for the DE particles are as measured by the method discussed above for the expanded milled perlite particles.

According to the present invention, the DE particles have a D₅₀ from about 10 to about 50 microns, such as from about 15 to about 45 microns, or from about 20 to about 40 microns, or from about 25 to about 35 microns. In certain embodiments, the DE particles have a D₅₀ of about 35 microns.

In certain embodiments, the DE particles have a bulk density of from about 0.05 g/cm³ to about 0.46 g/cm³, such as from about 0.06 g/cm³ to about 0.44 g/cm³, such as from about 0.07 g/cm³ to about 0.42 g/cm³, such as from about 0.08 g/cm³ to about 0.4 g/cm³, such as from about 0.09 g/cm³ to about 0.38 g/cm³, such as such as from about 0.10 g/cm³ to about 0.36 g/cm³, such as from about 0.11 g/cm³ to about 0.34 g/cm³, such as from about 0.12 g/cm³ to about 0.32 g/cm³.

In one embodiment, the DE particles is a commercially available diatomaceous earth product. In another embodiment, the at least one natural diatomaceous earth particles is a DiaFil® material available from Imerys Performance Materials.

### Binder

According to the present invention the expanded milled perlite particles and/or DE are bound together using a cross-linked binder to form a composite particulate. The cross-linked binder is a reaction product of a polymer and a cross-linking agent, wherein the polymer is selected from water-soluble synthetic polymers and natural water-soluble polymers.

The binder of the present invention is a permanent binder. By this, we mean that the binder is intended to remain in the composite particulate product and provide structural strength to the composite particulates without being soluble in the liquid to be filtered, for example, when filtering beer.

In certain embodiments, the binder consists of a single type of polymer, or in certain embodiments the binder comprises one or more polymers.

In certain embodiments, the polymer is selected from one or more of a water-soluble synthetic polymer and natural water-soluble polymer. In certain embodiments, the polymer is a combinations of these types of polymers.

In certain embodiments the binder comprises a water-soluble synthetic polymer selected from, for example, polyvinyl alcohol (PVA), polyethylene glycol, urea formaldehyde, polyacrylamide, microcrystalline cellulose, polyacrylates, acrylic/maleic copolymers and polyvinylpyrrolidone.

In certain embodiments, the binder comprises of natural water-soluble polymers, for example, xanthan gum, sodium alginate, potassium alginate, lignosulfonate, locust bean gum, pectin, dextran, carrageenan, agar, xanthan gum, guar gum, Arabic gum (acacia), cellulose ethers such as methyl cellulose and ethyl cellulose, starch or starch-based derivatives.

According to the present invention, the binder is a cross-linked binder which is a reaction product of a polymer and a cross-linking agent. Cross-linking is the formation of chemical links between polymer chains to form a three-dimensional network of connected molecules. The polymer may be selected from the list of polymers described above. Cross-linking agents are well-known in the art and may be selected depending on the type of polymer. The cross-linking agent is not a self-crosslinking polymer.

In certain embodiments, the cross-linking agent is an acid selected from one or more of the following:
(i) dicarboxylic acids, including oxalic acid, malonic acid, succinic acid, glutaric acid, adipic acid, pimelic acid. Suberic acid, azelaic acid, sebacic acid, malic acid, tartaric acid, tartronic acid, aspartic acid, glutamic acid, fumaric acid, itaconic acid, maleic acid, traumatic acid, camphoric acid, phthalic acid and its derivatives that contain at least one boron or chlorine atom, tetrahydrophthalic acid and its derivatives that contain at least one chlorine atom, isophthalic acid, terephthalic acid, mesaconic acid and citraconic acid,
(ii) tricarboxylic acids, including citric acid, tricarballylic acid, 1,2,4-butanetricarboxylic acid, aconitic acid, hemimellitic acid, trimellitic acid and trimesic acid;
(iii) tetracarboxylic acids, including 1,2,3,4-butanetetracarboxylic acid and pyromellitic acid;
(iv) polycarboxylic acids such as EDTA;
(v) unsaturated carboxylic acids including eth)acrylic acid, crotonic acid, isocrotonic acid, maleic acid, cinnamic acid, 2-methylmaleic acid, fumaric acid, itaconic acid, 2-methylitaconic acid, α,β-methyleneglutaric acid and monoesters of unsaturated dicarboxylic acids, and the vinyl monomer is styrene optionally substituted with alkyl, hydroxyl or sulfonyl groups, or with a halogen atom, (meth)acrylonitrile, (meth)acrylamide optionally substituted with C 1-C 10 alkyl groups, alkyl (meth)acrylates, glycidyl (meth)acrylate, butadiene and a vinyl ester
(vi) inorganic acids such as boric acid and phosphoric acid.

In certain embodiments, the cross-linking agent is a carboxylic acid selected from a dicarboxylic acid, tricarboxylic acid, tetracarboxylic acid, polycarboxylic acid and unsaturated carboxylic acid. In certain embodiments, the carboxylic acid is a polycarboxylic acid such as citric acid or succinic acid. In certain embodiments, the carboxylic acid is an unsaturated carboxylic acid such as acrylic acid, methacrylic acid and maleic acid.

In certain embodiments the binder is a reaction product of polyvinyl alcohol and citric acid. Carboxylic acids are a preferred type of cross-linker because of their low toxicity and cost. Polyvinyl alcohol is also known for being nontoxic and biodegradable. The resulting cross-linked binder is insoluble in water and cheap to produce.

In certain embodiments, the binder is present in an amount of from about 0.1 wt. % to about 40 wt. % of the total wt. % of the granulate, or from about 1 to wt. % to about 35 wt. % of the total wt. % of the granulate, or from about 5 wt. % to about 30 wt. % of the total wt. % of the granulate, or from about 10 wt. % to about 25 wt. % of the total wt. % of the granulate, or from about 15 wt. % to about 20 wt. % of the total wt. % of the granulate, or from or from about 1 wt. % to about 5 wt. % of the total wt. % of the granulate.

In certain embodiments, the binder comprises from about 1 wt % to about 30 wt %, or such as about 2 wt % to about 25 wt %, or such as about 3 wt % to about 20 wt %, or such as about 4 wt % to about 15 wt %, or such as about 5 wt % to about 10 wt % of a cross-linking agent, based on the total weight of the binder.

### Composite Particulates

According to the present invention the mineral particles selected from the group consisting of expanded milled perlite particles diatomaceous earth particles and combinations thereof, having the particle size described above, are bound together using a binder to form composite particulates. The primary powder particles agglomerate to form larger, multiparticle entities called composite particulates.

In certain embodiments, the composite particulates comprises or consists of expanded milled perlite particles and a binder. In certain embodiments, the composite particulates comprises or consists of DE particles and a binder. In certain embodiments, the composite particulates comprises or consists of a blend of expanded milled perlite particles and DE particles and a binder.

The expanded milled perlite and/or DE particles are bound/agglomerate together by the binder forming pores or otherwise known as interstitial void spaces between the particles. In some embodiments, the pores have a measurable intrusion volume which can be measured by a method which is explained in the Measurement Method section below. In certain embodiments, the cumulative intrusion volume is from about 2.5 mL/g to about 4.5 mL/g, or about 2.6 mL/g, or about 2.7 mL/g, or about 2.8 mL/g, or about 2.9 mL/g, or about 3.0 mL/g, or about 3.1 mL/g, or about 3.2 mL/g, or about 3.3 mL/g, or about 3.4 mL/g, or about 3.5 mL/g, or about 3.6 mL/g, or about 3.7 mL/g, or about 3.8 mL/g, or about 3.9 mL/g, or about 4.0 mL/g, or about 4.1 mL/g, or about 4.2 mL/g, or about 4.3 mL/g, or about 4.4 mL/g, or about 4.5 mL/g. In certain embodiments, the median intrusion volume is preferably about 3.5 mL/g.

The measured pore volume has advantageously been found to be more than 25% greater than typically used perlite or DE products. Such as higher pore volume means that there is more volume per mass that can pass through the filter. This allows for a greater solid holding capacity at an equivalent filter aid dosage.

In certain embodiments the composite particulates comprise expanded milled perlite particles and diatomaceous earth particles, and wherein at least one pore of the porous structure is filled with at least one unbound diatomaceous earth particle.

In certain embodiments, the ratio of expanded milled perlite to DE can be from about 5:1 to about 1:4 or about 5:1 to about 1:3, or about 5:1 to about 1:2, or about 5:1 to about 1:1, or about 5:1 to about 2:1, or about 5:1 to about 1:3, or about 4:1 to about 1:4 or about 4:1 to about 1:3, or about 4:1 to about 1:2, or about 4:1 to about 1:1, or about 4:1 to about 2:1, or about 4:1 to about 1:3.

According to the present invention, the composite particulate has a D₅₀, by laser diffraction method of from about 150 to about 2000 microns, for example, of from about 200 microns to about 1900 microns, or from about 300 microns to about 1800 microns, or from about 400 microns to about 1700 microns or from about 500 microns to about 1600 microns, or from about 600 microns to about 1500 microns, or from about 700 microns to about 1400 microns, or from about 800 microns to about 1300 microns, or from about 900 microns to about 1200 microns, or from about 1000 microns to about 1100 microns, or from about 200 microns to about 600 microns, such as from about 350 microns to about 550 microns, or from about 400 microns to about 500 microns, or from about 600 microns to about 1900 microns, such as from about 700 microns to about 1800 microns, or from about 800 microns to about 1600 microns, or from about 900 microns to about 1500 microns, or from about 1000 microns to about 1400 microns, or from about 1100 microns to about 1300 microns. The composite particulates may have a D₅₀, by laser of from about 200 microns to about 1000 microns, or from about 300 microns to about 900 microns, or from about 400 microns to about 800 microns, or from about 500 microns to about 700 microns.

In certain embodiments, the composite particulate has a bulk density of from about 0.1 g/cm³ to about 0.50 g/cm³, such as from about 0.15 g/cm³ to about 0.45 g/cm³, such as from about 0.20 g/cm³ to about 0.40 g/cm³, such as from about 0.20 g/cm³ to about 0.35 g/cm³, such as from about 0.25 g/cm³ to about 0.30 g/cm³.

The composite particulate of the present invention may have a measurable BET surface area. BET specific surface area refers to the area of the surface of the particles of the composite particulate with respect to unit mass, determined according to the BET method by the quantity of nitrogen adsorbed on the surface of said particles so as to form a monomolecular layer completely covering said surface (measurement according to the BET method, AFNOR standard X11-621 and 622 or ISO 9277). Details of the BET specific surface area measurement method used in the preparation of the present application are set out in the Examples.

The composite particulate may have a BET specific surface area no less than about 1.5 m²/g, for example, no less than about 1.6 m²/g, or no less than about 1.7 m²/g, or no less than about 1.8 m²/g, or no less than about 1.9 m²/g, or no less than about 2.0 m²/g, or no less than about 2.5 m²/g, or no less than about 3.0 m²/g, or no less than about 5.0 m²/g, or no less than about 10 m²/g (e.g. 10.0 m²/g), or no less than about 20 m²/g (e.g. 11.0 m²/g). The composite particulate may have a BET specific surface area no greater than about 50 m²/g (e.g. 50.0 m²/g), for example, no greater than about 40 m²/g (e.g. 40.0 m²/g), or no greater than about 30 m²/g, (e.g. 30.0 m²/g) or no greater than about 20 m²/g (e.g. 20.0 m²/g), or no greater than about 15 m²/g (e.g. 15.0 m²/g), or no greater than about 12 m²/g (e.g. 12.0 m²/g), or no greater than about 11 m²/g (e.g. 11.0 m²/g), or no greater than about 10 m²/g (e.g. 10.0 m²/g), or no greater than about 8.0 m²/g, or no greater than about 7.0 m²/g, or no greater than about 6.0 m²/g. The composite particulate may have a BET specific surface area may be from about 1.5 m²/g to about 50 m²/g (e.g. 50.0 m²/g), for example, from about 2 m²/g to about 40 m²/g (e.g. 40.0 m²/g), or from about 5 m²/g to about 30 m²/g (e.g. 30.0 m²/g), or from about 10 m²/g to about 20 m²/g (e.g. 20.0 m²/g).

In certain embodiments, the composite particulate has an angle of repose of about 5° to about 35°, as measured by the angle of repose (funnel method) using the EFT-01 Powder Flow Tester; the composite particulate has an absorption capacity of at least 150%, as measured using the Westinghouse method described herein in the experimental section and utilizing dioctyladipate as the absorbate; and a dust content less than 10, as measured by the Dust analyzer DustmonRD 100.

The angle of repose of a material is the steepest angle of decent or dip relative to the horizontal plane to which a material can be piled without slumping. The morphology of the material affects the angle of repose. When bulk granular materials are poured onto a horizontal surface, a conical pile will form. The internal angle between the surface of the pile and the horizontal surface is known as the angle of repose and is related to the density, surface area and shapes of the particles, and the coefficient of friction of the material. Material with a low angle of repose forms flatter piles than material with a high angle of repose. Thus, smooth rounded sand grains cannot be piled as steeply as rough interlocking sands. The method for calculating the angle of repose is described in more detail below in the experimental section.

In certain embodiments the angle of repose (of the dry product) is about 5° to about 35°, such as about 10° to about 30°, such as about 15° to about 25°.

In certain embodiments the composite particulate has an advantageously low dust content (measured using the Dust Analyzer Dustmon RD 100 (available from Retsch®)) of less than 10, such as less than 9, or 8. The method for calculating the dust content value is explained in more detail in the experimental section.

### Composition

According to the present invention there is provided a composition comprising composite particulates. The composite particulates are bound together using a cross-linked binder.

In certain embodiments, the composition comprises an additional inorganic mineral component. Examples of additional inorganic mineral components include natural or synthetic silicate or aluminosilicate materials, pumicite, natural glass, cellulose, activated charcoal, feldspars, nepheline syenite, sepiolite, zeolite and clay. Examples of clay minerals include halloysite, kaolinite and bentonite. The additional inorganic mineral component may be added in an amount of from about 0.01 parts to about 10 parts per parts of expanded milled perlite and/or DE, such as about 0.5 to about 5 parts.

The composition is prepared by dry-blending the one or more mineral particles (dry powders of the expanded milled perlite and/or DE, as well as any other desired additional inorganic materials) and then spray-drying the one or more mineral particles with a binder such that agglomerates form. The binder has firstly been prepared by dissolving the binder ingredients in water.

When spray-drying, the aqueous binder mixture is fed to the inlet of a spray-dryer and sprayed onto the dry-blended mineral particles. One example of a suitable spray-drying apparatus is a Niro Minor spray dryer unit. This machine has a drying chamber 800 mm in diameter, 600 mm cylindrical height being conical based and is fitted with an air driven disc type atomiser. The atomiser may be run at a speed of 30,000 rpm.

The curing step (cross-linking step) is then performed at a temperature of from about 80-120 °C in a kiln. The curing step is typically performed for a length of time such that the granulate has dried and the binder has cured. After the curing step is performed, the moisture content of the granulate is below about 5 wt % of the granulate, such as less than about 3 wt %, or less than about 2 wt %. The curing step is performed for a length of time that the moisture content reaches the desired level as stated above, and may take 12 hours, or 8 hours or 4 hours.

This is a much lower temperature than for the standard production of DE, where the kiln temperatures can exceed 1400 °C. By avoiding the use of such high temperatures, and by keeping the temperature low, it is possible to prevent the unwanted formation of crystalline silica such as quartz or cristobalite. The presence of cristobalite is generally undesirable in filter aids because it is known for its potentially unhealthy properties in higher concentrations.

In certain embodiments, the total content of crystalline silica present in the composition is less than or equal about 0.2 wt % of the total wt. % of the composition. In certain embodiments, the composition comprises from about 0 wt % to about 0.2 wt %, such as from about 0.01 wt % to about 0.1 wt % of crystalline silica present in the composition. In certain embodiments, the composition is free of crystalline silica, meaning that there is no crystalline silica detected.

Methods of measuring cristobalite content may be measured using techniques known to the person skilled in the art, including the specific method described in WO 2010/042614.

### Filter Aid Material

According to the present invention, there is provided a filter aid material comprising the composition described herein. The filter aid composition may be formed into sheets, pads, cartridges, or other products which are used to perform the function of filtration.

The filter aids of the present invention may be used in a variety of processes and compositions as well as in a variety of filtering methods. In certain embodiments, the filter aid material is applied to a filter septum to protect it and/or improve the clarity of the liquid to be filtered in a filtration process. In another embodiment, the filter aid composition is added directly to a beverage to be filtered to increase flow rate and/or extend the filtration cycle. In another embodiment, there is provided a method of pre-coating at least one filter element with the filter aid material and contacting at least one liquid to be filtered with the at least one coated filter element or to be used in body feeding, or a combination of both pre-coating and body feeding.

The filter aid material of the invention may also be used in a variety of filtering methods. In one embodiment, the filtering method comprises pre-coating at least one filter element with the composition of the invention, and contacting at least one liquid to be filtered with the at least one coated filter element. In such an embodiment, the contacting may comprise passing the liquid through the filter element. In another embodiment, the filtering method comprises suspending the filter aid material in at least one liquid containing particles to be removed from the liquid, and then separating the filter aid material from the filtered liquid.

Filter aid materials comprising compositions of the present invention may also be employed to filter various types of liquids. The skilled person is readily aware of liquids that may be desirably filtered with a process comprising the filter aids comprising at least one diatomaceous earth product disclosed herein. In one embodiment, the liquid is a beverage. Exemplary beverages include, but are not limited to, vegetable-based juices, fruit juices, distilled spirits, and malt-based liquids. Exemplary malt-based liquids include, but are not limited to, beer and wine. In another embodiment, the liquid is one that tends to form haze upon chilling. In a further embodiment, the liquid is a beverage that tends to form haze upon chilling. In yet another embodiment, the liquid is a beer. In yet a further embodiment, the liquid is an oil. In still another embodiment, the liquid is an edible oil. In still a further embodiment, the liquid is a fuel oil. In another embodiment, the liquid is water, including but not limited to waste water. In a further embodiment, the liquid is blood. In yet another embodiment, the liquid is a sake. In yet a further embodiment, the liquid is a sweetener, such as for example corn syrup or molasses.

### EXAMPLES

Details for comparative DE samples, comparative perlite samples, and Novel Composites of DE and expanded milled perlite used in the following examples are shown in Table 1 below.

TABLE 1

| | | Perlite | DE | Binder | Binder | | CAS |
|---|---|---|---|---|---|---|---|
| Sample | Trade Name | % | % | type | Amount | Calcined | number |
| A | Hyflo ® | 0 | 100 | None | 0 | Y | 68855-54-9 |
| | | | | | | (flux- | |
| | | | | | | cal) | |
| B | Standard | 0 | 100 | None | 0 | Y | 91053-39-3 |
| | Super Cel ® | | | | | | |
| C | Harborlite ® | 100 | 0 | None | 0 | N | 93763-70-3 |
| | H500 | | | | | | |
| D | Harborlite ® | 100 | 0 | None | 0 | N | 93763-70-3 |
| | H200 | | | | | | |
| E | DiaFil ® | NA | NA | NA | NA | N | 61790-53-2 |
| | 615 - not | | | | | | |
| | separately | | | | | | |
| | tested | | | | | | |
| F | Novel | 75 | 19 | PVA/CA | 5.6 | N | — |
| | Composite 1 | | | | | | |
| | (NC1) | | | | | | |
| G | Novel | 63 | 31 | PVA/CA | 5.6 | N | — |
| | Composite 2 | | | | | | |
| | (NC2) | | | | | | |

### Example 1

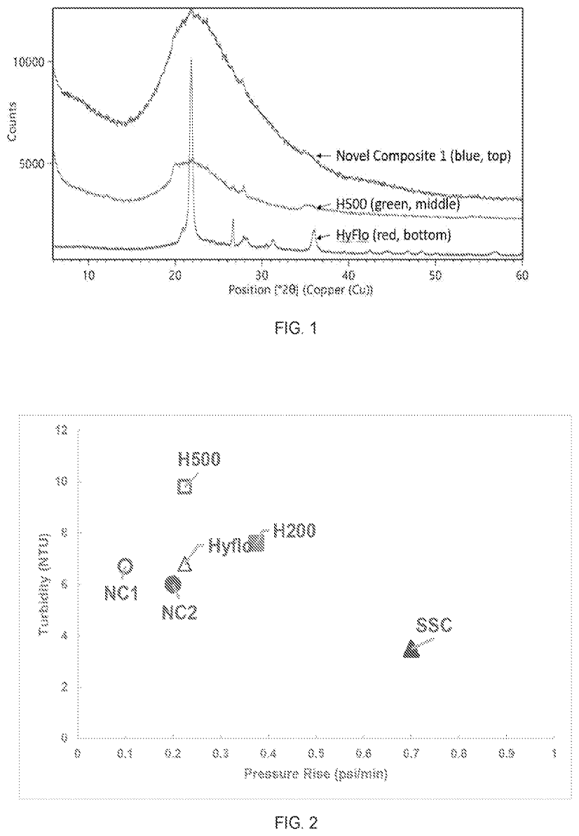

Novel Composite 1 (Sample F) was prepared using 80 g of expanded milled perlite (Harborlite® 500 available from Imerys—Sample C) which was placed in a mixer (Kitchen Aid mixer) with 20 g of natural diatomaceous earth (DiaFil® 615-Sample E) and the powders were dry blended on the lowest setting for 5 minutes. 1.5 g Polyvinyl alcohol (PVA) and 4.5 g citric acid were dissolved in 50 g water. The final % by weight of the binder was 6% by weight of the total composite particulate. The binder composition was then sprayed on to the dry blended powders and the composite particulate formed by agglomeration, taking 3 minutes to transfer all the solution to the Kitchen Aid mixer. The composite particulate was then cured by heating in an oven at a temperature of 120 °C for 85 minutes. Novel Composite 1 was subjected to X-Ray diffraction, Walton solid-liquid filtration, and mercury porosimetry by the methods as described hereinbelow, and the results are shown in FIGS. 1, 2 and 3, respectively.

### Example 2

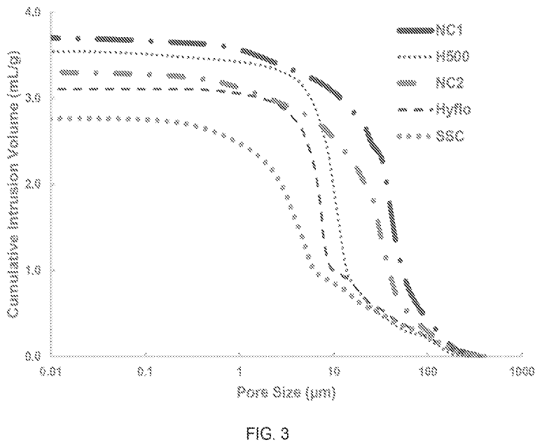

Novel Composite 2 (Sample G) was prepared using 66 g of expanded milled perlite (Harborlite® 500 available from Imerys—Sample C) which was placed in a mixer (Kitchen Aid mixer) with 33 g of natural diatomaceous earth (DiaFil® 615—Sample E) and the powders were dry blended on the lowest setting for 5 minutes. 1.5 g Polyvinyl alcohol (PVA) and 4.5 g citric acid were dissolved in 50 g water. The final % by weight of the binder was 6% by weight of the total composite particulate. The binder composition was then sprayed on to the dry blended powders and the composite particulate formed by agglomeration, taking 3 minutes to transfer all the solution to the Kitchen Aid mixer. The composite particulate was then cured by heating in an oven at a temperature of 120 °C for 85 minutes. Novel Composite 2 was subjected to Walton solid-liquid filtration, and mercury porosimetry by the methods as described hereinbelow, and the results are shown in FIGS. 2 and 3, respectively.

The filtration performance of Novel Composites 1 and 2 demonstrate their competitiveness with standard grades of DE coming from the Lompoc facility when tested in the Walton filter (vertical tank, single horizontal leaf, positive pressure, Ovaltine as a suspended solid). The Novel Composites 1 and 2, representative of the inventive compositions described herein, demonstrate that the inventive compositions described herein deliver the clarity of Hyflo (Sample A) with reduced pressure rise over time. Compared to perlite the inventive compositions described herein significantly outperform H500 (Sample C) in terms of clarity at a comparable pressure and outperform H200 (Sample D) in clarity at substantially reduced pressure, as shown in FIG. 2.

In addition to filtration performance it is also important to note the increase in pore volume vs. Hyflo (Sample A—3.1 mL/g) and Standard Supercel (Sample B—2.8 mL/g); each of which are standard Lompoc DE grades, for Novel Composites 1 and 2, as shown in FIG. 3. Typical calcined and flux calcined DE grades have a pore volume of approximately 2.8 mL/g when measured in a mercury porosimeter. Novel Composite 1 has a pore volume measured at 3.7 mL/g, an increase of 25% over typical DE. This allows for more solids holding capacity at equivalent filter aid dosage.

### Measurement Methods

### PSD Laser

The Particle Size Distribution (PSD) was determined using a Mastersizer 3500S from Malvern instruments.

D₅₀ is the value of the mean particle size (d50) measured by laser diffraction (standard NFX-11-666 or ISO 13320-1), as described above and in the Examples. Reference may be made to the article by G. Baudet and J. P. Rona, Ind. Min. Mines et Carr. Les techn. June, July 1990, pp 55-61, which shows that the lamellarity index is correlated to the mean ratio of the largest dimension of a particle to its smallest dimension.

### Density

The bulk density of the samples was assessed by measuring a volume of the sample into a test tube and comparing the volume of the sample against the mass of the sample.

Specific Surface Area (SSA—B.E.T m²/g)

The BET specific surface area was determined using a method based on the standard NF X 11-621 titled “Détermination de l'aire massique (surface spécifique) des poudres par adsorption de gaz—Méthode B.E.T.—Mesure volumétrique par adsorption d'azote á basse température” (Determination of mass area (specific surface) of powders by gas adsorption—BET Methods—Volumetric measurement by nitrogen adsorption at low temperature).

The method made use of a Micromeritics measurement apparatus (available from Micromeritics Instrument Corp., USA) including a vacuum pump, a VacPrep 061 degassing section, a Tristar 3000S measurement section and sample holders, a Mettler AG204 scale with a precision of 0.1 mg, Dewar flasks, nitrogen adsorbant gas and helium carrier gas.

The sample was weighed (to 0.1 mg accuracy) near the empty sample holder and its mass M₀ was recorded in g. The previously homogenised powder sample was then introduced, using a funnel, into the sample holder. Sufficient space (dead volume) was left between the sample and the top of the sample holder to enable free circulation of gas. The sample holder was placed into one of the degassing stations and degassed at 250 °C under a primary vacuum of 10 Pa for about 20 minutes. After degassing, a sufficient volume of nitrogen was added to the sample holder to avoid introducing air during transfer of the sample holder from the degassing station to the measurement station.

The sample holder was then attached to the measurement station and a Dewar flask containing liquid nitrogen was placed around the sample holder. The BET measurement was commenced using the device control software. The device then carried out the following operations automatically:
Vacuum removal of the nitrogen introduced for the transfer of the sample holder;
Leak test;
Adding helium carrier gas;
Measuring the dead volume at ambient temperature;
Measuring the cold dead volume using liquid nitrogen;
Helium vacuum removal;
Leak test;
Adding nitrogen at 950 mm Hg and measuring the saturation pressure; and
Acquisition of analysis values.

The instrument's data acquisition and processing software plotted the transformed BET line from 5 measured adsorption points. The Dewar flask and then the sample holder were removed. The apparatus was allowed to return to ambient temperature and then the sample was again weighed (to an accuracy of 0.1 mg) near the sample holder and the weight was recorded as M₂ in g. The mass of the test portion of the sample, M, was calculated (in g) according to:

M=M₂−M₀

The value M was then introduced into the software calculation program which automatically calculated the BET specific surface area of the sample in m²/g.

### Porosity

Porosity is the percentage of interstitial void space in a particulate. It is calculated using the following formula:

φ=Vᵥ/V_{T}

Where φ is the porosity, Vᵥ is the void volume and V_{T} is the total volume.

The porosity was measured using mercury porosimetry which characterizes porosity by forcing mercury into pores. The method used herein for measuring porosimetry was the standard test for mercury porosimetry as set out in ASTM D4404-18.

### Angle of Repose

The angle of repose was measured using a Manual Powder Flow Tester (EFT-01) following ISO 8398:1989. The angle of repose is calculated as follows:

Θ=tan ⁻¹ h/r

Where Θ is the angle of repose, h is the height in cm of the conical pile and r is the radius in cm.

The complementary measurement to the angle of repose is the dynamical angle of repose (or flowing angle) which is measured using a Granudrum. The GranuDrum instrument (available from GRANUTOOLS™) is an automated powder flowability measurement technique predicated on the rotating drum principle. The drum is a horizontal cylindrical with transparent sidewalls and it is half-filled with the powder sample.

The drum rotates about its axis at an angular velocity varying from 2 to 70 rpm. In this case the angular velocity was measured at 10 rpm and a CCD camera captures a number of snapshots. For the measured rotating speed, the dynamic cohesive index is measured from the interface fluctuations, and the flowing angle, also called “dynamic angle of repose” in the literature, is calculated from the average interface position. A low value of the flowing angle corresponds to excellent flowability.

### XRD

X-ray diffraction is used to identify and quantify mineral species, e.g. crystalline and inorganic species. A sample holder was filled with approximately 1 gram of powder sample and placed on the XRD machine, a Rigaku Empyrean using a Ge monochromator to generate CuK_{α} radiation. The scan range in 2θ angles are from 2° to 70°.

Crystalline Silica (“CS”) has a primary dominating peak at or near 21.5°. Hyflo shows at low count intensities the distinguishing primary peak with characteristic secondary and tertiary peak signals for CS. The perlite (H500) and Novel Composites 1 and 3 even at very high counting intensities have very weak signals in this range.

### Walton

A 4 L solids suspension was prepared as a model solids solution using Ovaltine, consisting of 5 g/L Ovaltine in deionized water. This was hydrated for 45 minutes. A pressure vessel was filled with deionized water and a Hyflo precoat (2.0g in 50 mL) was made on a 20 cm² Stainless Steel dutch weave screen. This precoat was added at a flow rate of 150 mL/min. Once this was applied, the turbidity was monitored using a nephelometer by measuring NTU, targeting NTU<1. Upon 45 minutes of Ovaltine hydration, the respective sample filter aid was added to the 4 L solids suspension at a concentration of 2 g/L. The Ovaltine and filter aid suspension is called the body feed. The body feed was dosed into the pressure vessel at 60 mL/min for 30 minutes. The pressure and turbidity were monitored every minute. The pressure rise was taken from 10 minutes to 20 minutes and turbidity reported at 20 minutes for the Walton graph in FIG. 2.

The perlite grades (H500 and H200) show a higher turbidity relative to the diatomaceous earths (Hyflo and Standard Supercel) and to the Novel Composites 1 and 2. The perlite grades show a higher pressure rise relative to the Novel Composites 1 and 2. The diatomaceous grades show a higher pressure rise relative to the Novel Composites 1 and 2. Further, the Hyflo turbidity is higher than the Novel Composites 1 and 2, all as shown in FIG. 2.

1. A composition comprising composite particulates, the composite particulates comprising a cross-linked binder and mineral particles selected from the group consisting of: i) expanded milled perlite particles having a D₅₀ from about 5 to about 40 microns; ii) diatomaceous earth particles having a D₅₀ of from about 10 to about 50 microns; and combinations thereof;
wherein the mineral particles are bound together by the cross-linked binder to form composite particulates wherein the composite particulates have a D₅₀ of from about 20 to 100 microns,
wherein the binder is present in an amount of 0.1 to about 40 wt %, based on the total weight of the composition; and
wherein the cross-linked binder is a reaction product of a polymer and a cross-linking agent, the polymer being selected from water-soluble synthetic polymers and natural water-soluble polymers.

2. The composition according to claim 1, wherein the cross-linking agent is an acid selected from one or more of the following:
(i) dicarboxylic acids, including oxalic acid, malonic acid, succinic acid, glutaric acid, adipic acid, pimelic acid, suberic acid, azelaic acid, sebacic acid, malic acid, tartaric acid, tartronic acid, aspartic acid, glutamic acid, fumaric acid, itaconic acid, maleic acid, traumatic acid, camphoric acid, phthalic acid and its derivatives that contain at least one boron or chlorine atom, tetrahydrophthalic acid and its derivatives that contain at least one chlorine atom, isophthalic acid, terephthalic acid, mesaconic acid and citraconic acid,
(ii) tricarboxylic acids, including citric acid, tricarballylic acid, 1,2,4-butanetricarboxylic acid, aconitic acid, hemimellitic acid, trimellitic acid and trimesic acid;
(iii) tetracarboxylic acids, including 1,2,3,4-butanetetracarboxylic acid and pyromellitic acid;
(iv) polycarboxylic acids such as EDTA;
(v) unsaturated carboxylic acids including ethylene acrylic acid, crotonic acid, isocrotonic acid, maleic acid, cinnamic acid, 2-methylmaleic acid, fumaric acid, itaconic acid, 2-methylitaconic acid, α,β-methyleneglutaric acid and monoesters of unsaturated dicarboxylic acids, and styrene, wherein the styrene is optionally substituted with alkyl, hydroxyl or sulfonyl groups, or with a halogen atom, (meth)acrylonitrile, (meth)acrylamide optionally substituted with C1-C10 alkyl groups, alkyl (meth)acrylates, glycidyl (meth)acrylate, butadiene and a vinyl ester
(vi) inorganic acids such as boric acid and phosphoric acid.

3. The composition according to claim 2, wherein the binder is a reaction product of polyvinyl alcohol and an acid.

4. The composition according to claim 3, wherein the acid is citric acid.

5. The composition according to claim 1 wherein the composite particulates are bound by the cross-linked binder and form a porous structure which comprises pores having a pore volume of from 2.5 mL/g to 4.5 ml/g.

6. The composition according to claim 5, wherein the composite particulates comprise expanded milled perlite particles and diatomaceous earth particles.

7. The composition according to claim 6, and wherein at least one pore of the porous structure is filled with at least one unbound diatomaceous earth particle.

8. The composition according to claim 1, having:
an angle of repose of about 5° to about 30°, as measured by the angle of repose (funnel method) using the EFT-01 Powder Flow Tester;
an absorption capacity of at least 150%, as measured using the Westinghouse method described herein and utilizing dioctyladipate as the absorbate; and
dust content less than 10, as measured by the Dust analyzer Dustmon RD 100.

9. The composition according to claim 1, wherein the expanded milled perlite particles have a D₅₀ of about 15 microns.

10. The composition according to claim 1, wherein the diatomaceous earth particles have a D₅₀ of about 35 microns.

11. The composition according to claim 1, wherein the composite particles have a D₅₀ of from about 30 to about 40 microns.

12. The composition according to claim 1, wherein the composite particulate comprises both expanded milled perlite particles and diatomaceous particles in a ratio of from 5:1 to 1:4.

13. The composition according to claim 1, wherein the crystalline silica present in the composition is less than or equal about 0.2 wt % of the total wt. % of the composition.

14. A filter aid material comprising the composition according to claim 1.

15. A method of filtering a liquid, the method comprising contacting the liquid with a filter aid material according to claim 12.

16. A method of preparing a composition comprising composite particulates, the method comprising:
(a) spray-drying mineral particles selected from the group consisting of: (i) expanded milled perlite particles having a D₅₀ from about 5 to about 40 microns; (ii) diatomaceous earth particles having a D₅₀ of from about 10 to about 50 microns; and (iii) combinations thereof with a cross-linked binder to form composite particulates, and
(b) curing the composite particulates in a kiln,
wherein the composite particulates have a D₅₀ of from about 20 to 100 microns,
wherein the binder is present in an amount of 0.01 to 20 wt %, based on the total weight of the composition,
wherein the cross-linked binder is a reaction product of a polymer and a cross-linking agent, and
wherein the polymer is selected from water-soluble synthetic polymers and natural water-soluble polymers.

17. The method according to claim 14, wherein the curing step is carried out at a temperature of from 80-300 °C in a kiln.

18. The method according to claim 15, wherein the curing step is performed for between 4 to 12 hours.
